(19) United States
(12) Patent Application Publication
(10) Pub. No.: US 2010/0154897 A1
(43) Pub. Date: Jun. 24, 2010

(54) VALVE DEVICE FOR AN INFLATABLE OBJECT

(76) Inventor: Hsin-Tsai WU, Taipei City (TW)

Correspondence Address: GREENBLUM & BERNSTEIN, P.L.C., 1950 ROLAND CLARKE PLACE, RESTON, VA, 20191, US

(21) Appl. No.: 12/408,971

(22) Filed: Mar. 23, 2009

(30) Foreign Application Priority Data
Dec. 23, 2008 (CN) 200820206268.0

(51) Int. Cl. F16K 15/20

(52) U.S. Cl. 137/223

(57) ABSTRACT

A valve device for an inflatable object includes a seat body, a valve body with a deformable surrounding wall which is movable between a vaulted position, where inflating air is admitted through an inflating port, and a depressed position, where the inflating port is closed by a tubular plug member of the seat body, a check valve unit which is disposed in the tubular plug member to be closed and opened by virtue of a pressure differential established between an internal air pressure within the inflatable object and a back pressure of the inflating air, and a plunger rod which extends from a valve disc of the check valve unit and which is operable to cause the check valve unit to open so as to allow a small amount of air to escape from the inflatable object.

### CROSS-REFERENCE TO RELATED APPLICATION

This application claims priority of Chinese Utility Model Application No. 200820206268.0, filed on Dec. 23, 2008, the disclosure of which is herein incorporated by reference.

### BACKGROUND OF THE INVENTION

1. Field of the Invention

This invention relates to a valve device for an inflatable object, more particularly to a valve device adapted to be secured to an inflatable object for inflation and deflation of the object.

2. Description of the Related Art

With reference to FIGS. 1 to 3, in co-pending U.S. patent application Ser. No. 11/359,564, the applicant disclosed a valve device 2 that includes a rigid seat body 21 which is secured to an inflatable object 1, and a deformable valve body 22 connected to the seat body 21. These at body 21 defines a plurality of communicating holes 212 in fluid communication with an inflating chamber 11 of the object 1, and has a plug member 211 which defines a plurality of air passageways 213 extending therethrough and in fluid communication with the inflating chamber 11. The valve body 22 has a surrounding wall 221 which is movable between a vaulted position (see FIG. 2) and a depressed position (see FIG. 3), and a tubular wall 222 which defines an inflating port 223. An end cap 24 includes a tubular mount 241 fitted to the tubular wall 222, and a cap 242 threadedly engaged with the tubular mount 241. Thus, the inflating chamber 11 can be filled with air through the inflating port 223 and the communicating holes 212 when the surrounding wall 221 is in the vaulted position. When inflation is completed, the surrounding wall 221 can be forced to move to the depressed position such that the inflating port 223 is closed by the plug member 211. Since the air pressure in the inflating chamber 11 is larger than the atmospheric pressure, the air within the inflating chamber 11 will force a check valve 23 to abut against the plug member 211 to thereby close the air passageways 213 for preventing leakage of air.

When it is desired to add a small amount of air to the inflating chamber 11, the user may remove the cap 242 and conduct inflation through the tubular mount 241 without moving the surrounding wall 221 to the vaulted position. On the other hand, if the object 1 is over-inflated, the valve body 22 can be pulled to move the surrounding wall 221 to the vaulted position, and the cap 242 is subsequently rotated relative to the tubular mount 241 to allow a small amount of air to escape.

It is desirable to improve the aforesaid valve device to facilitate inflation of an inflatable object with a small amount of air and release of a small amount of air from the inflatable object.

### SUMMARY OF THE INVENTION

An object of the present invention is to provide a valve device which permits inflation of an object with a small amount of air and release of a small amount of air from the object without undesired air leakage.

According to this invention, the valve device includes a seat body which is adapted to be secured to an inflatable object, and which includes a surrounding abutment member surrounding an axis, and a tubular plug member. The tubular plug member has an inner tubular surface which defines a passageway in fluid communication with an inflating chamber of the object and which includes upstream and downstream tubular regions, and an outer tubular surface which is spaced apart from the surrounding abutment member by a surrounding communicating port in fluid communication with the inflating chamber. A valve body includes a surrounding flange which is connected to the surrounding abutment member, a deformable surrounding wall which extends from the surrounding flange towards the axis to terminate at an inner periphery, and which is movable along the axis between a vaulted position, where the inner periphery is remote from the upstream tubular region, and a depressed position, where the inner periphery is close to the downstream tubular region, and a tubular wall which extends upwardly from the inner periphery and which defines an inflating port. When the deformable surrounding wall is moved to the depressed position, the tubular wall is brought into air-tight engagement with the outer tubular surface so as to interrupt fluid communication between the inflating port and the surrounding communicating port. A check valve unit includes a check valve seat disposed on the downstream tubular region, and a check valve disc which is disposed downstream of the check valve seat and which is movable along the axis between a non-blocking position, where the check valve disc is kept away from the check valve seat by a back pressure of inflating air so as to admit the inflating air into the inflating chamber, and a blocking position, where the check valve disc is kept in engagement with the valve seat by an internal air pressure within the inflating chamber when the internal air pressure is higher than the back pressure. A plunger rod extends from the check valve disc through the check valve seat to terminate at an actuated end which is located proximate to the upstream tubular region and which is operable to move the check valve disc to a non-blocking position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a valve device disclosed in co-pending U.S. patent application Ser. No. 11/359,564;

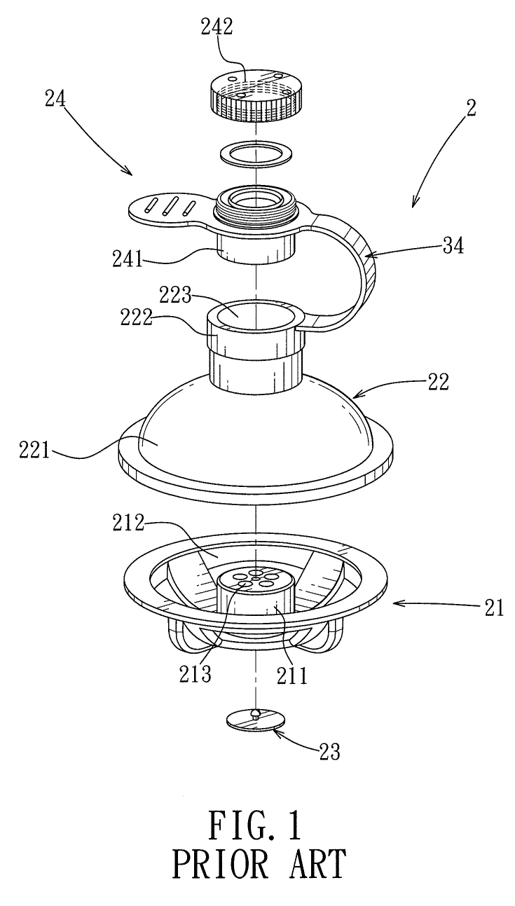

FIGS. 2 and 3 are sectional views illustrating a valve body of the valve device of FIG. 1 in vaulted and depressed positions, respectively;

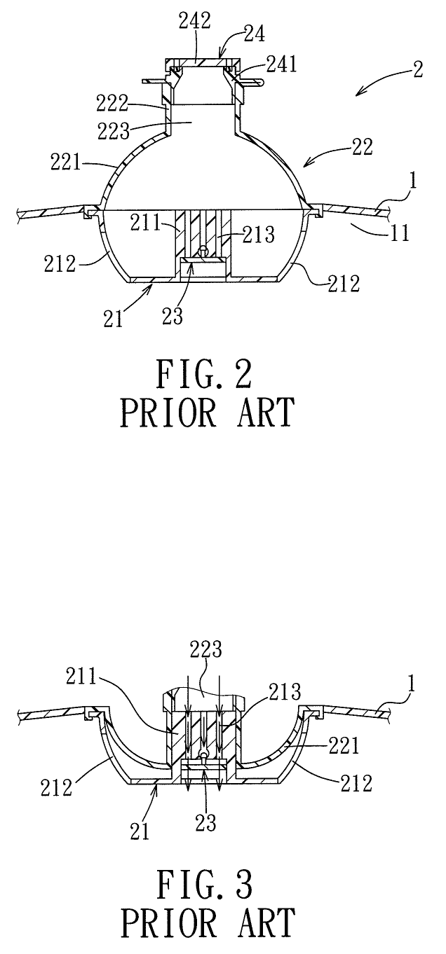

FIG. 4 is an exploded perspective view of the preferred embodiment of a valve device according to this invention;

FIG. 5 is a sectional view of the preferred embodiment;

FIG. 6 is a sectional view showing an inflatable object equipped with the valve device of the preferred embodiment in an inflated state;

FIG. 7 is a sectional view showing the valve device of the preferred embodiment in a closed state;

FIG. 8 is a sectional view showing how the inflatable object equipped with the valve device of the preferred embodiment is supplemented with a small amount of air; and

FIG. 9 is a sectional view showing that the inflatable object equipped with the valve device of the preferred embodiment is slightly deflated.

### DETAILED DESCRIPTION OF THE PREFERRED EMBODIMENT

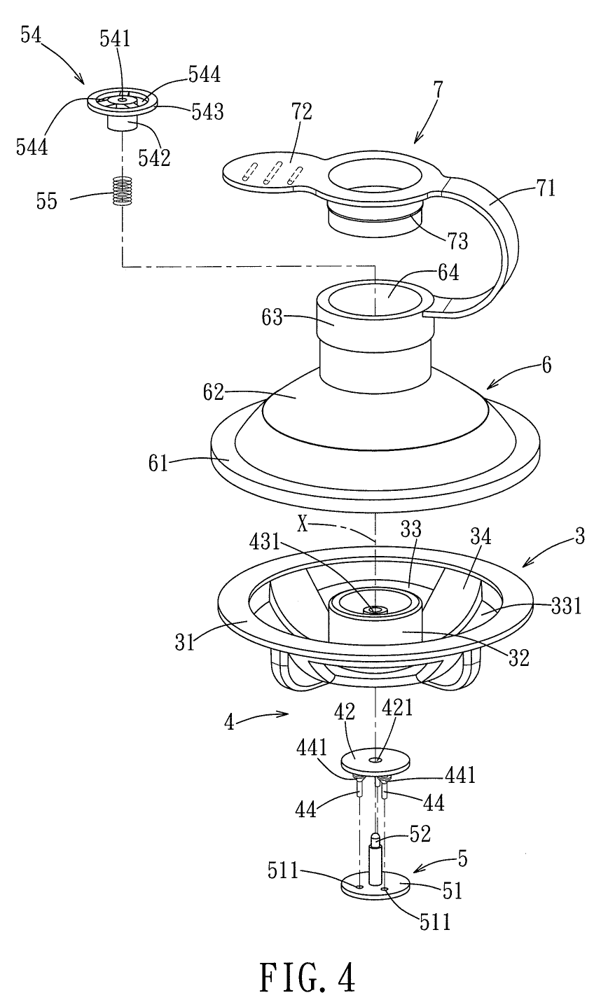

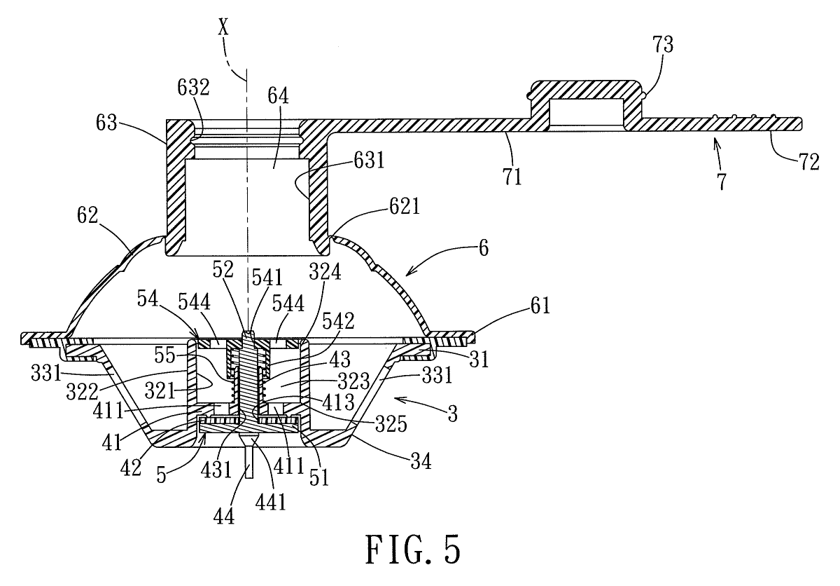

Referring to FIGS. 4 to 6, the preferred embodiment of a valve device according to the present invention is shown to comprise a seat body 3, a valve body 6, a check valve unit 4, a plunger rod 5, and an end cap 7.

The seat body 3 is adapted to be secured to an inflatable object 9 between an inflating chamber 91 of the object 9 and an access opening 92 communicated with the inflating chamber 91, and is made from a rigid material. The seat body 3 includes a surrounding abutment member 31 surrounding an axis (X), and a tubular plug member 32 which has inner and outer tubular surfaces 321,322 opposite to each other in radial directions. The inner tubular surface 321 defines a passageway 323 that extends along the axis (X), and that is in fluid communication with the inflating chamber 91, and includes upstream and downstream tubular regions 324,325 opposite to each other along the axis (X) in terms of an inflating direction. The outer tubular surface 322 is spaced apart from the surrounding abutment member 31 by a surrounding communicating port 33 that is in fluid communication with the inflating chamber 91. A plurality of interconnecting ribs 34 span the surrounding communicating port 33 to interconnect the surrounding abutment member 31 and the tubular plug member 32 so as to divide the surrounding communicating port 33 into a plurality of communicating holes 331.

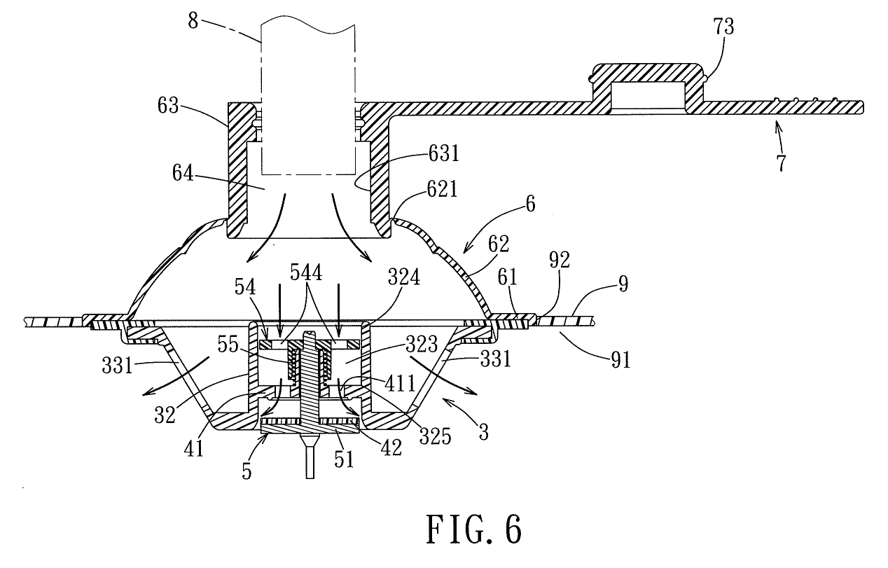

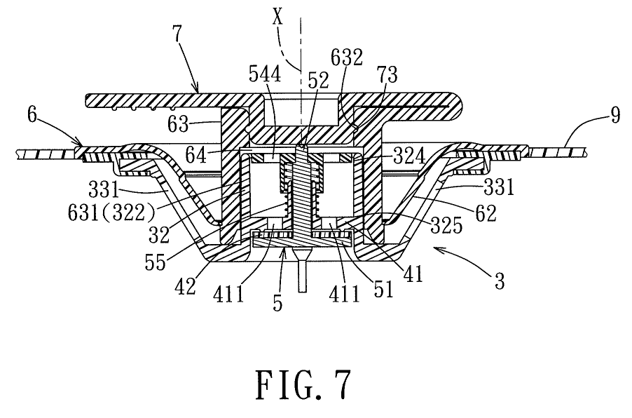

The valve body 6 is made from a deformable material, and includes a surrounding flange 61 which surrounds the axis (X) and which is connected to and which abuts against the surrounding abutment member 31, a deformable surrounding wall 62 which extends from the surrounding flange 61 towards the axis (X) to terminate at an inner periphery 621, and a tubular wall 63 which extends upwardly along the axis (X) from the inner periphery 621 of the deformable surrounding wall 62. The deformable surrounding wall 62 is movable along the axis (X) between a vaulted position, as shown in FIG. 6, where the inner periphery 621 is remote from the upstream tubular region 324, and a depressed position, as shown in FIG. 7, where the inner periphery 621 is close to the downstream tubular region 325. The tubular wall 63 has an inner surrounding surface 631 which defines an inflating port 64. The inner surrounding surface 631 is configured such that, when the deformable surrounding wall 62 is moved to the depressed position (see FIG. 7), the inner surrounding surface 631 is brought into air-tight engagement with the outer tubular surface 322 so as to interrupt fluid communication between the inflating port 64 and the communicating holes 331.

The check valve unit 4 includes a check valve seat 41 and a check valve disc 42. The check valve seat 41 is integrally formed with the downstream tubular region 325, and has a plurality of passage holes 411. A tubular post 43 extends from the check valve seat 41 along the axis (X) and defines a tubular guideway 431. The check valve disc 42 is made from an elastomeric material, is disposed downstream of the check valve seat 41, and is movable along the axis (X) between a non-blocking position, where the check valve disc 42 is kept away from the check valve seat 41 so as to admit inflating air into the inflating chamber 91, and a blocking position, where the check valve disc 42 is kept in engagement with the valve seat 41. A plurality of connecting posts 44 are integrally formed with and extend downwardly from the check valve disc 42.

The plunger rod 5 includes a plate-shaped mounting end 51 connected to the check valve disc 42 by the connecting posts 44 which are extended through holes 511 in the mounting end 51 such that enlarged portions 441 of the connecting posts 44 are retained in the holes 511. The plunger rod 5 extends upwardly through a central hole 421 in the check valve disc 42, the check valve seat 41, and the tubular post 43 to terminate at an actuated end 52 that is located proximate to the upstream tubular region 324. Thus, the plunger rod 5 is guided by the tubular guideway 431 to move with the check valve disc 42 along the axis (X).

Preferably, an abutment seat 54 is connected to the actuated end 52 by insertion of the actuated end 52 into a through hole 541 in the abutment seat 54 such that the abutment seat 54 is movable with the actuated end 52. The abutment seat 54 has a tubular portion 542 which permits passage of the actuated end 52 therethrough, a guiding rim 543 which is fittingly slidable relative to the inner tubular surface 321 so as to stabilize the movement of the plunger rod 5, and a plurality of vent holes 544 disposed between the guiding rim 543 and the through hole 541. A biasing member 55 in the form of a coiled spring 55 is sleeved on the plunger rod 5. The coiled spring 55 has an end sleeved on the tubular post 43, and an opposite end inserted into the tubular portion 542 so as to bias the check valve disc 42 to the blocking position. It is noted that the actuated end 52 may be secured to the abutment seat 54 by means of adhesive, a C-ring, etc.

The end cap 7 is connected to the tubular wall 63 by a deformable connecting strip 71 so as to detachably close the inflating port 64, and has a tab 72 for gripping by the user, and an annular protrusion 73 which fittingly engages an annular groove 632 in the inner surrounding surface 631 of the tubular wall 63 so as to ensure air-tightness between the end cap 7 and the tubular wall 63.

Referring to FIG. 6, when it is desired to inflate the object 9, the deformable surrounding wall 62 is placed in the vaulted position and the end cap 7 is removed from the inflating port 64. An adaptor 8 of an air supply (not shown) is then connected to the tubular wall 63 to introduce air into the inflating chamber 91 through the inflating port 64 and the communicating holes 331. Certainly, some air will flow through the passageway 323, and the coiled spring 55 will be compressed by the back pressure of the inflating air, thereby permitting downward movement of the abutment seat 54 as well as the plunger rod 5 and the check valve disc 42 to the non-blocking position. Thus, air can flow through the vent holes 544 and the passage holes 411 into the inflating chamber 91. Since the internal air pressure in the inflating chamber 91 is increased during inflation, the valve disc 42 is gradually moved toward the blocking position by the biasing action of the coiled spring 55. Once the internal air pressure is higher than the back pressure, or once the air supply is removed, the check valve disc 42 is immediately engaged with the check valve seat 41 to be disposed in the blocking position, as shown in FIG. 7, thereby completing the inflation operation. At this stage, the end cap 7 can be moved to close the inflating port 64 so as to achieve air-tight engagement between the annular protrusion 73 and the annular groove 632, and the valve body 6 can be depressed to move the deformable surrounding wall 62 to the depressed position.

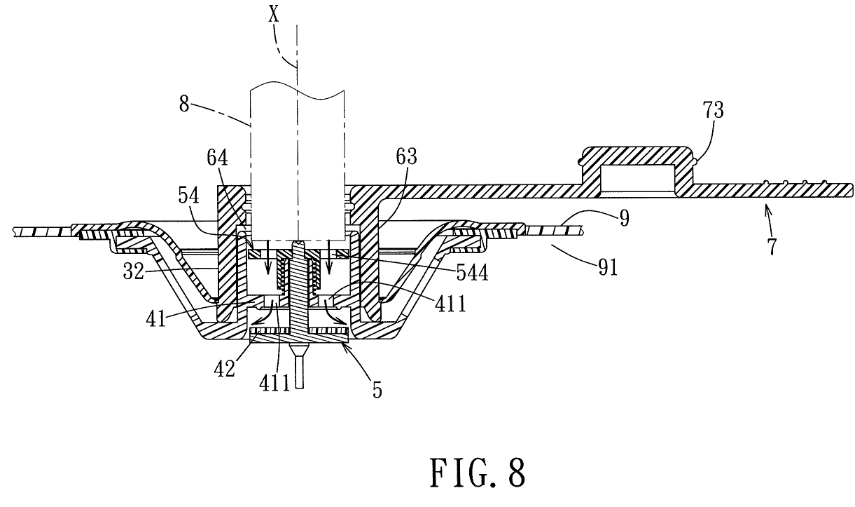

Referring to FIG. 8, when the amount of air within the inflating chamber 91 is not sufficient so that addition of a small amount of air to the inflating chamber 91 is required, the user only needs to remove the end cap 7 from the inflating port 64 and connect the adaptor 8 of the air supply to the inflating port 64, or simply blow air into the inflating port 64, to generate a back pressure to move the check valve disc 42 away from the check valve seat 41 so as to inflate the object 9 through the vent holes 544 and the passage holes 411.

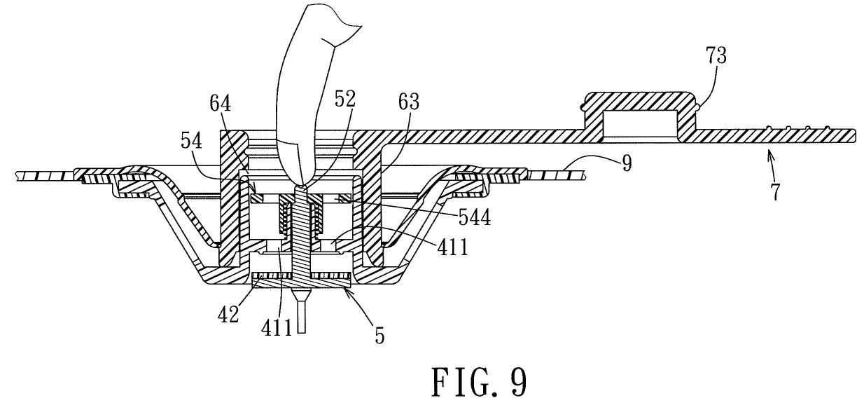

Referring to FIG. 9, when the object 9 is over-inflated so that release of a small amount of air from the inflating chamber 91 is required, the user only needs to remove the end cap 7 from the inflating port 64 and press the actuated end 52 with his/her finger so as to move the check valve disc 42 to a non-blocking position. Thus, a desirable amount of the air can be allowed to escape through the passage holes 411 and the vent holes 544.

As illustrated, by means of the tubular plug member 32 which plugs the tubular wall, and the check valve disc 42 which blocks the passage holes 411, and by virtue of the air-tight engagement between the end cap 7 and the inner surrounding surface 631 of the tubular wall 63, an effective sealing effect can be achieved to prevent undesirable leakage of air from the inflatable object 9. In addition, due to the provision of the check valve unit 4, when the deformable surrounding wall 62 is in the depressed position, a small amount of air can be added to the inflating chamber 91 by introducing air into the inflating chamber 91 through the passageway 323 while preventing leakage of air during the operation. Moreover, it only requires removal of the end cap 7 and depressing of the actuated end 52 to release the air inside the inflating chamber 91 in small amounts when the deformable surrounding wall 62 is in the depressed position, which is therefore relatively convenient.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A valve device adapted to be secured to an inflatable object which has an inflating chamber and an access opening communicated with the inflating chamber, said valve device comprising:
a seat body adapted to be mounted between the access opening and the inflating chamber, and including
a surrounding abutment member surrounding an axis, and
a tubular plug member having
an inner tubular surface which defines a passageway that extends along the axis, and that is adapted to be in fluid communication with the inflating chamber, and which includes upstream and downstream tubular regions opposite to each other along the axis in terms of an inflating direction, and
an outer tubular surface which is opposite to said inner tubular surface in radial directions, and which is spaced apart from said surrounding abutment member by a surrounding communicating port that is adapted to be in fluid communication with the inflating chamber;
a valve body including
a surrounding flange which surrounds the axis and which is connected to and which abuts against said surrounding abutment member,
a deformable surrounding wall which extends from said surrounding flange towards the axis to terminate at an inner periphery, and which is movable along the axis between a vaulted position, where said inner periphery is remote from said upstream tubular region, and a depressed position, where said inner periphery is close to said downstream tubular region, and
a tubular wall which extends upwardly along the axis from said inner periphery of said deformable surrounding wall, and which has an inner surrounding surface that defines an inflating port, said inner surrounding surface being configured such that, when said deformable surrounding wall is moved to the depressed position, said inner surrounding surface is brought into air-tight engagement with said outer tubular surface so as to interrupt fluid communication between said inflating port and said surrounding communicating port;
a check valve unit which includes a check valve seat disposed on said downstream tubular region, and a check valve disc which is disposed downstream of said check valve seat and which is movable along the axis between a non-blocking position, where said check valve disc is kept away from said check valve seat by a back pressure of an inflating air so as to admit the inflating air into the inflating chamber, and a blocking position, where said check valve disc is kept in engagement with said valve seat by an internal air pressure within the inflating chamber when the internal air pressure is higher than the back pressure; and
a plunger rod extending from said check valve disc through said check valve seat to terminate at an actuated end which is located proximate to said upstream tubular region and which is operable by a user so as to move said check valve disc to a non-blocking position.

2. The valve device according to claim 1, further comprising a biasing member disposed to bias said check valve disc to the blocking position.

3. The valve device according to claim 2, wherein said biasing member is disposed between said actuated end and said check valve disc such that the biasing force of said biasing member is a function of a pressure differential established between the internal air pressure and the back pressure.

4. The valve device according to claim 3, further comprising an abutment seat which is movable with said actuated end, and which is configured to engage said biasing member so as to compress said biasing member when said plunger rod is moved with said check valve disc towards the non-blocking position.

5. The valve device according to claim 4, wherein said abutment seat has a guiding rim configured to be fittingly slidable relative to said inner tubular surface so as to stabilize movement of said plunger rod.

6. The valve device according to claim 5, wherein said biasing member is a coiled spring which is sleeved on said plunger rod.

7. The valve device according to claim 6, further comprising a tubular post which extends from said check valve seat along the axis and which defines a tubular guideway to guide said plunger rod to move with said check valve disc along the axis.

8. The valve device according to claim 1, further comprising an end cap which is disposed to detachably close said inflating port.

9. The valve device according to claim 6, wherein said inner surrounding surface of said tubular wall and said end cap respectively have an annular groove and an annular protrusion which are disposed to fittingly engage each other so as to ensure air-tightness between said tubular wall and said end cap.

10. The valve device according to claim 6, further comprising a connecting strip which interconnects said end cap and said tubular wall.
